(19) United States
(12) Patent Application Publication
(10) Pub. No.: US 2018/0103190 A1
(43) Pub. Date: Apr. 12, 2018

(54) Remote Camera Control in a Peer-to-Peer Camera Network

(71) Applicant: GoPro, Inc., San Mateo, CA (US)

(72) Inventors: Bich Nguyen, Los Altos, CA (US); David A. Boone, Belmont, CA (US)

(21) Appl. No.: 15/286,572

(22) Filed: Oct. 6, 2016

(51) Int. Cl. H04N 5/232; H04N 5/247

(52) U.S. Cl. CPC H04N 5/23206; H04N 5/247; H04N 5/23245

(57) ABSTRACT

A camera is configured with a multi-camera control engine that facilitates the creation and operation of a peer-to-peer camera network including the camera. The multi-camera control engine enables the camera to remotely broadcast its state information with other cameras in the camera network. The remaining cameras, upon receiving a broadcasted state, mimic the broadcasted state. In such a manner, the camera, via the multi-camera control engine, remotely controls other cameras in the camera network.

### BACKGROUND

### 1. Field of Art

The disclosure generally relates to the field of digital image and video capture and processing, and more particularly to remote camera control in a peer-to-peer camera network.

### 2. Description of the Related Art

Modern digital cameras typically have the ability to connect with external devices, for example microphones, headphones, and remote controls. A remote control connected to the camera allows a user to remotely control the operation and the settings of the camera without physically manipulating the camera. In some cases, the user operates multiple cameras at a given time. To remotely control the cameras, the user uses individual remote controls for each of the cameras or uses the same remote control to individually manipulate the cameras. Using external remote controls in such a manner is tedious and does not make for a friendly user experience.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 is a block diagram illustrating an example camera architecture, according to one embodiment.

FIG. 2 is a conceptual diagram illustrating a camera network including multiple cameras configured to share states, according to one embodiment.

FIG. 3 is a block diagram of the multi-camera control engine of FIG. 1, according to one embodiment.

FIG. 4 is a flow diagram illustrating a process for cameras in a camera network remotely controlling one another, according to one embodiment.

FIG. 5 is a flow diagram illustrating a process for a camera in a camera network to distribute connection information to other cameras in the camera network for forming independent connections with each other, according to one embodiment

FIG. 6A illustrates a front perspective view of an example camera, according to one embodiment.

FIG. 6B illustrates a rear perspective view of an example camera, according to one embodiment

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable, similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Example Camera Architecture

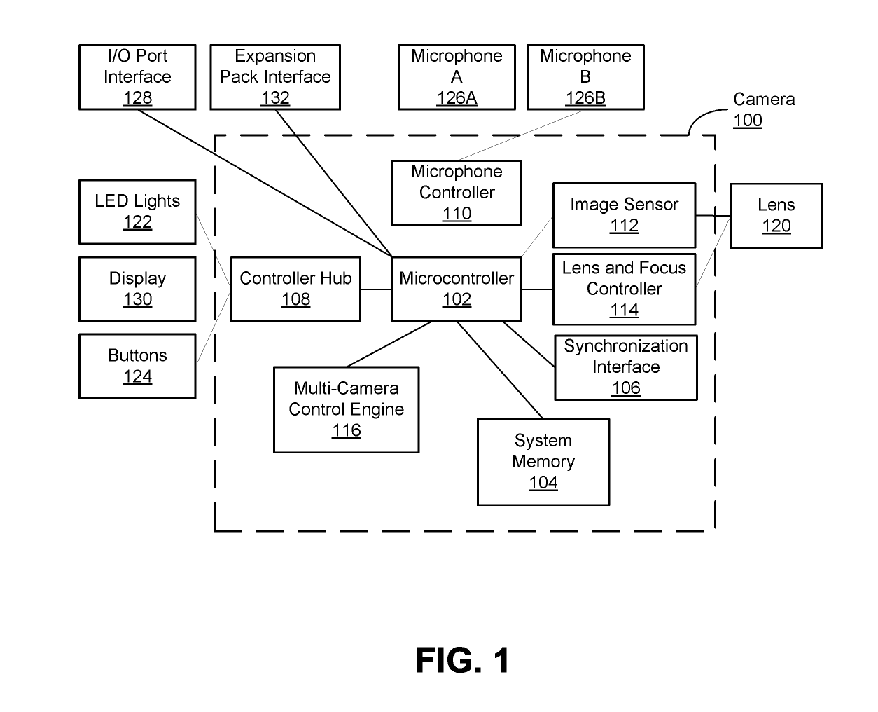

FIG. 1 is a block diagram illustrating an example camera architecture, according to one embodiment. The camera 100 of the embodiment of FIG. 1 includes one or more microcontrollers 102, a system memory 104, a synchronization interface 106, a controller hub 108, one or more microphone controllers 110, an image sensor 112, a lens and focus controller 114, a multi-camera control engine 116, one or more lenses 120, one or more LED lights 122, one or more buttons 124, one or more microphones 126, an I/O port interface 128, a display 130, and an expansion pack interface 132. Various embodiments may have additional, omitted, or alternative modules configured to perform at least some of the described functionality. It should be noted that in other embodiments, the modules described herein can be implemented in hardware, firmware, or a combination of hardware, firmware, and software. In addition, in some embodiments, the illustrated functionality is distributed across one or more cameras or one or more computing devices.

The camera 100 includes one or more microcontrollers 102 (such as a processor) that control the operation and functionality of the camera 100. For instance, the microcontrollers 102 can execute computer instructions stored on the system memory 104 to perform the functionality described herein. It should be noted that although the functionality herein is described as being performed by the camera 100, in practice, the camera 100 may capture image data, provide the image data to an external system (such as a computer, a mobile phone, or another camera), and the external system may filter the captured image data and correct any resulting disturbance introduced into the filtered image data.

The system memory 104 is configured to store executable computer instructions that, when executed by the microcontroller 102, perform the camera functionalities described herein. The system memory 104 also stores images captured using the lens 120 and image sensor 112. The system memory 104 can include volatile memory (e.g., random access memory (RAM)), non-volatile memory (e.g., a flash memory), or a combination thereof

The lens and focus controller 114 is configured to control the operation, configuration, and focus of the camera lens 120, for example, based on user input or based on analysis of captured image data. The image sensor 112 is a device capable of electronically capturing light incident on the image sensor 112 and converting the captured light to image data. The image sensor 112 can be a CMOS sensor, a CCD sensor, or any other suitable type of image sensor, and can include corresponding transistors, photodiodes, amplifiers, analog-to-digital converters, and power supplies.

The synchronization interface 106 is configured to communicatively couple the camera 100 with external devices, such as a remote control, another camera (such as a slave camera or master camera), a computer, or a smartphone. The synchronization interface 106 may transfer information through a network, which allows coupled devices, including the camera 100, to exchange data over local-area or wide-area networks. The network may contain a combination of wired or wireless technology and make use of various connection standards and protocols, such as WiFi, IEEE 1394, Ethernet, 802.11, 4G, or Bluetooth.

The controller hub 108 transmits and receives information from user I/O components. In one embodiment, the controller hub 108 interfaces with the LED lights 122, the display 130, and the buttons 124. However, the controller hub 108 can interface with any conventional user I/O component or components. For example, the controller hub 108 may send information to other user I/O components, such as a speaker.

The microphone controller 110 is configured to control the operation of the microphones 126. The microphone controller 110 receives and captures audio signals from one or more microphones, such as microphone 126A and microphone 126B. Although the embodiment of FIG. 1 illustrates two microphones, in practice, the camera can include any number of microphones. In some embodiments, the microphone controller 110 selects which microphones from which audio data is captured. For instance, for a camera 100 with multiple microphone pairs, the microphone controller 110 selects one microphone of the pair to capture audio data.

Additional components connected to the microcontroller 102 include an I/O port interface 128 and an expansion pack interface 132. The I/O port interface 128 may facilitate the camera 100 in receiving or transmitting video or audio information through an I/O port. Examples of I/O ports or interfaces include USB ports, HDMI ports, Ethernet ports, audio ports, and the like. Furthermore, embodiments of the I/O port interface 128 may include wireless ports that can accommodate wireless connections. Examples of wireless ports include Bluetooth, Wireless USB, Near Field Communication (NFC), and the like. The expansion pack interface 132 is configured to interface with camera add-ons and removable expansion packs, such as an extra battery module, a wireless module, and the like.

The multi-camera control engine 116 is configured to facilitate the creation and operation of a peer-to-peer camera network (also referred to herein as “camera network”) including camera 100. The multi-camera control engine 116 enables camera 100 to remotely broadcast its state information with other cameras in the camera network. As used herein, a “camera state” refers to a camera setting, configuration, mode of operation, or function. The remaining cameras, upon receiving a broadcasted state, mimic the broadcasted state by configuring themselves to mirror the broadcasted state. In such a manner, the camera 100, via the multi-camera control engine 116, remotely controls other cameras in the camera network. In the illustrated embodiment of Fig.1, multi-camera control engine 116 is located within the camera 100. In some embodiments, the multi-camera control engine 116 is located external to the camera 100, for instance, in a post-processing computer system, in a remote controller, in a cloud server, and the like.

### Remote Control of Cameras in Camera Network

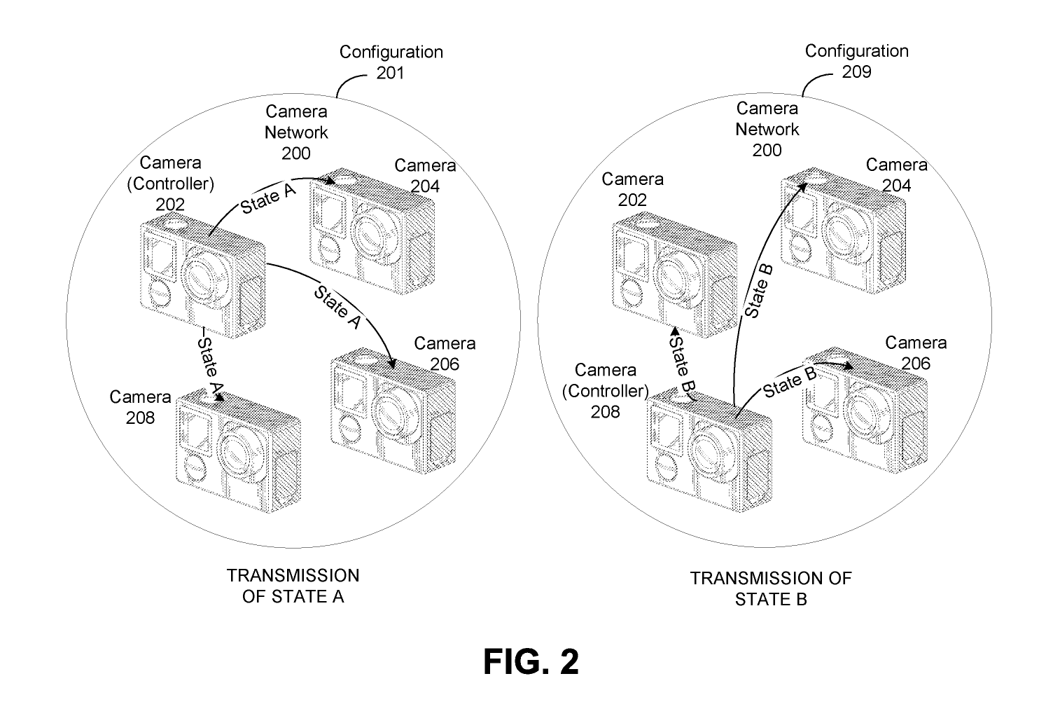

FIG. 2 is a conceptual diagram illustrating a camera network 200 including multiple cameras configured to share states, according to one embodiment.

Camera network 200 includes cameras 202, 204, 206, and 208. In one embodiment, the cameras 202-208 are located within a threshold distance from one another so as to allow communication among the cameras via short range communication protocols, e.g., Bluetooth or near field communication (NFC). In other embodiments, the cameras are dispersed over a large distance such that the cameras communicate via longer range communication protocols, e.g., WiFi, IEEE 1394, Ethernet, 802.11, 3G, and Long-Term Evolution (LTE).

Within the camera network 200, each camera 202-208 may operate as both a controller and as a recipient. A camera configured to operate as a controller (or “controller camera” hereinafter) broadcasts its state to the other cameras in the camera network 200 configured to operate as recipients (or “recipient cameras” hereinafter), and the recipient cameras attempt to mimic the broadcasted state. As will be discussed below, a broadcasted camera state may be related to powering the camera on/off, configuring the camera to operate in various camera modes, performing image capturing or image tagging, and managing image storage.

As shown in configuration 201, camera 202 of camera network 200 is configured to operate as a controller camera and broadcasts state A to the recipient cameras 204, 206, and 208. In response to receiving state A, the recipient cameras 204, 206, and 208 mimic state A. In such a manner, controller camera 202 remotely controls the configuration or operation of recipient cameras 204, 206, and 208. In a particular example, when camera 202 captures an image, the image capture state is broadcasted to recipient cameras 204, 206, and 208. In response to the broadcast, cameras 204, 206, and 208 mimic the broadcasted state and also capture an image.

At a different point in time, as shown in the configuration 209, camera 208 is configured to operate as a controller camera and broadcasts state B to the recipient cameras 202, 204, and 206. In response to receiving state B, the recipient cameras 202, 204, and 206 mimic state B. In such a manner, controller camera 208 remotely controls the recipient cameras 202, 204, and 206. Because each camera in the camera network 200 may adopt the controller mode, any camera in the camera network 200 may remotely control other cameras in the camera network. Therefore, there is no single point of failure when controlling cameras in a camera network. Further, a user of the cameras in the camera network may beneficially cause a change of state of the entire camera network by manipulating the state of any camera in the camera network.

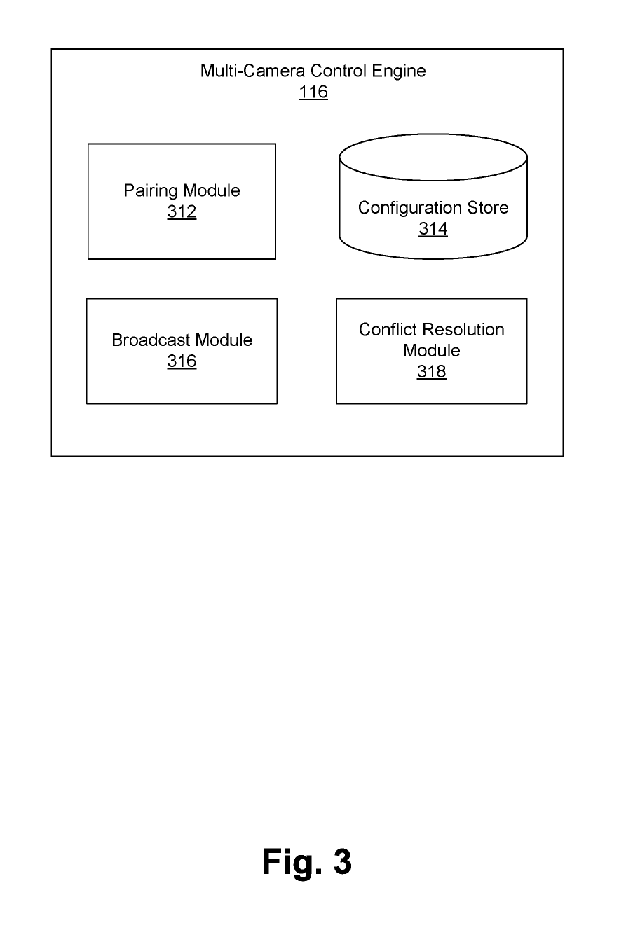

Each of the cameras 202-208 in the camera network 200 include at least the multi-camera control engine 116 of the camera architecture discussed in FIG. 1. The multi-camera control engine 116 facilitates the creation of the camera network, the broadcast and receipt of changes in state, and the mimicking of received states at recipient cameras. The details of the multi-camera control engine 116 are explained in conjunction with the description of FIGS. 3-5 below.

FIG. 3 is a block diagram of the multi-camera control engine 116 of FIG. 1, according to one embodiment. The multi-camera control engine 116 includes a pairing module 312, a configuration store 314, a broadcast module 316, and a conflict resolution module 318. The following description provides details about the multi-camera control engine 116 included in camera 202 that enables camera 202 to (i) form a camera network with remote cameras 204 and 206 and (ii) adopt and relinquish the controller mode in the camera network so as to remotely control cameras 204 and 206 and/or be remotely controlled by cameras 204 and 206.

The pairing module 312 of camera 202 identifies remote cameras, i.e., cameras 204 and 206, that are available to form a camera network and connects with each of the identified cameras to form a camera network. The pairing module 312 can implement the Bluetooth protocol for identifying, connecting to, and communicating with cameras 204 and 206 to form a camera network. In operation, to identify a camera available to form a camera network, the pairing module 312 broadcasts a discovery request that indicates to other cameras listening for such requests (e.g., cameras 204 and 206) that another camera is attempting to form a camera network. In response to receiving such a discovery request, each of cameras 204 and 206 individually transmits to the pairing module 312 unique connection information needed to form a connection with the camera. In one embodiment, each camera 204 and 206 also transmits its name and/or other relevant information that additionally identifies the camera.

The pairing module 312 transmits a connection request for forming a wireless connection with each of camera 204 and camera 206 based on the connection information received from the camera. The connection enables camera 202 to communicate directly with each of camera 204 and camera 206. In one embodiment, the pairing module 312 uses the synchronization interface 106 to form the connection with each of camera 204 and camera 206 based on the connection information received from the camera. The connection may be formed over, for instance, Bluetooth, near field communication (NFC), WiFi, IEEE 1394, Ethernet, 802.11, 3G, and Long-Term Evolution (LTE).

Prior to forming a connection, the pairing module 312 optionally engages in an authentication process with each of camera 204 and camera 206. The authentication process may involve a user entering an authentication code associated with camera 202 in a user interface on camera 204 or camera 206. When the authentication code is entered, the pairing module 312 can form a connection with the camera. In another embodiment, the authentication process may involve a user clicking a button (physical or on a graphical user interface) on camera 204 or camera 206 that allows the pairing module 312 to connect with the camera.

In one embodiment, instead of (or in conjunction with) broadcasting discovery requests, the pairing module 312 discovers cameras available to form a camera network using pairing data stored in the configuration store 314 to determine a whitelist of remote cameras (e.g., cameras 204 and 206) with which the pairing module 312 has previously formed a connection. The pairing data identifies, for each remote camera on the whitelist, the connection information needed to form a connection with the camera. The pairing module 312 uses the pairing data to form connections with any of the remote cameras on the whitelist that respond to connection requests transmitted by the pairing module 312.

As discussed above, both cameras 204 and 206 also include corresponding multi-camera control engines 116 that allow those cameras to perform the same functions as camera 202 with respect to forming a camera network. Thus, as camera 202 connects with cameras 204 and 206, the multi-camera control engine 116 of camera 204 independently connects with camera 206. In such a manner, a camera network including cameras 202, 204, and 206 is formed, where each camera in the camera network is connected to and therefore can independently communicate with every other camera in the camera network. In one embodiment, each camera in a camera network is connected to at least one other camera in the camera network, such that a given camera need not be connected to every other camera in the camera network.

In one embodiment, the configuration store 314 of camera 202 stores not only connection information needed for camera 202 to connect with other cameras, but also connection information needed for remote cameras to connect with one another (referred to herein as “third party connection information”). In such an embodiment, to facilitate forming the camera network, the pairing module 312 of camera 202 connects with cameras 204 and 206 and subsequently transmits to cameras 204 and 206 the third party connection information needed for those cameras to connect to one another. The third party connection information identifies, for each pair of remote cameras (e.g., cameras 204 and 206), connection information needed for the pair of remote cameras to connect with one another. The third party connection information associated with each pair of remote cameras may be provided by a user of camera 202. Alternatively, the third party connection information may be provided by the remote camera when camera 202 connects to the remote camera.

Once the camera network including cameras 202, 204, and 206 is formed, the broadcast module 316 of camera 202 operates in a controller mode to remotely control cameras 204 and 206 and/or a recipient mode to be remotely controlled by camera 204 and/or camera 206. When camera 202 experiences a change of state, the broadcast module 316, operating in controller mode, broadcasts the change of state over the connections with each of the other cameras in the camera network, i.e., cameras 204 and 206. The change of state may be caused by an internal operational change, such as an automatic focus of a lens, or may be caused by an external change, such as by a user of the camera (either by manipulating the camera itself or manipulating a remote controller coupled to the camera). In response to receiving the broadcast, the cameras, i.e., cameras 204 and 206, mimic the state indicated in the broadcast. Examples of state changes that are broadcasted by the broadcast module 316 include but are not limited to: a shutter operation, a lens focus operation, an image capture mode, entering low light mode, entering sleep mode, and a change in a setting of the camera (e.g., image capture resolution, zoom level, etc.).

In the recipient mode, the broadcast module 316 of camera 202 listens for broadcasts indicating changes of state and transmitted by other cameras in the camera network. In response to receiving such a broadcast, the broadcast module 316 causes camera 202 to mimic the state in the broadcast. In one embodiment, the broadcast module 316 operates in controller mode and recipient mode simultaneously such that, at any given time, the broadcast module 316 is able to remotely control other cameras in the camera network by broadcasting changes in state and also listen for broadcasts of state changes from the other cameras. In an alternative embodiment, the broadcast module 316 expressly adopts the controller mode and, while in controller mode, does not listen for broadcasts of state changes from other cameras. In such an embodiment, the broadcast module 316 may notify other cameras in the camera network that it has adopted the controller mode and, thus, no other camera can remotely control camera 202.

In one embodiment, when in the controller mode, the broadcast module 316 broadcasts metadata along with the state of camera 202. The metadata includes information that the recipient cameras may use to mimic the broadcasted state. An example of such metadata includes a tag that is stored with any image captured by the recipient camera when mimicking the state of camera 202. The tag may be provided by a user of camera 202 to indicate an event of interest during capture of image or may be automatically detected by camera 202. The tag may include an identifier associated with the camera network including camera 202 and the recipient camera, a timestamp, and/or a physical location of camera 202 or the camera network. Recipient cameras within the network, in response to receiving the tag, can associated the tag with video or images captured at substantially the same time as the image or video associated with the tag captured by the camera 202.

In one embodiment, the broadcast module 316 of camera 202 selects only a subset of the cameras in the camera network for mimicking the broadcasted state of camera 202. The broadcast module 316 may broadcast the state to only the selected cameras or, alternatively, may indicate as a part of the broadcast that only the selected cameras are to mimic the broadcasted state. The subset of the cameras may be selected by a user of camera 202. Alternatively, the subset of cameras may be selected automatically by the broadcast module 316 based on properties of the cameras in the camera network, e.g., physical location, image capture capabilities, and estimated or actual battery power available.

The conflict resolution module 318 of camera 202 resolves conflicts between two or more state changes broadcasted by other cameras in the camera network. In operation, when the broadcast module 316 is in the recipient mode, the broadcast module 316 may receive two or more state changes that are in conflict with one another such that the camera 202 can only mimic one of the state changes. An example of a conflicting state change may be the camera entering sleep mode and the camera capturing an image. When conflicting state changes are received, the broadcast module 316 transmits a request to the conflict resolution module 318 to resolve the conflict so that one of the conflicting state changes may be mimicked by the camera 202. The conflict resolution module 318 may implement one or more conflict resolution techniques for resolving the conflict. In one example, the conflict resolution module 318 resolves the conflict based on which state change was first received by the broadcast module 316. In another example, the conflict resolution module 318 resolves the conflict based on which of the cameras in the camera network 200 broadcasted the state changes as state changes broadcasted by certain cameras may be deemed to be of higher priority than other cameras. In other embodiments, the conflict resolution module 318 resolves the conflict based on a priority order associated with the types of states being broadcast, where the state corresponding to the highest priority is selected. The conflict resolution module 318, based on the conflict resolution techniques, selects one of the conflicting state changes and notifies the broadcast module 316 of the selected state change so that the camera 202 may mimic the selected state change.

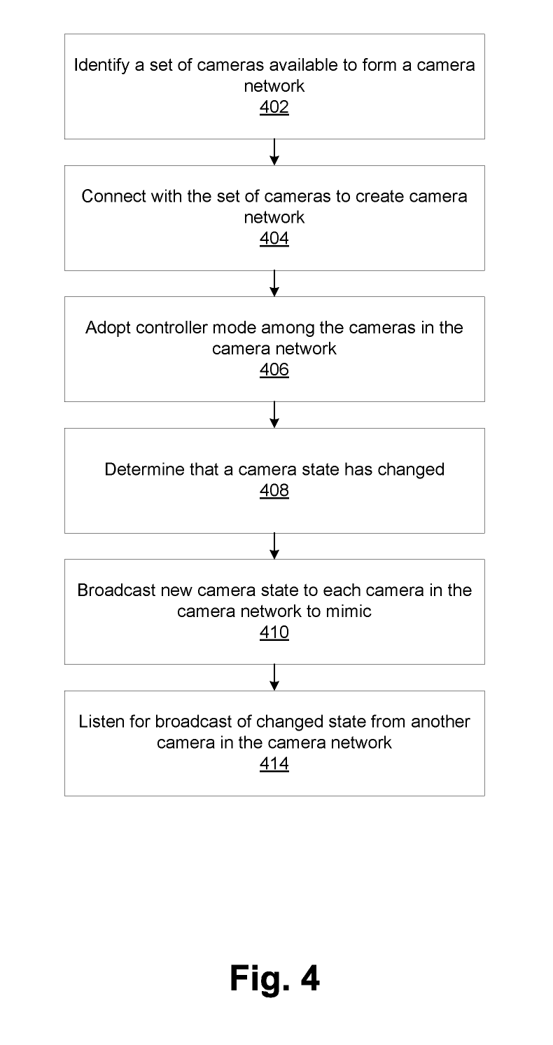

FIG. 4 is a flow diagram illustrating a process for cameras in a camera network remotely controlling one another, according to one embodiment.

The multi-camera control engine 116 in a given camera identifies 402 a set of remote cameras that are available to form a camera network. To identify a camera available to form a camera network, the multi-camera control engine 116 may broadcast a discovery request that indicates to other cameras listening for such requests that another camera is attempting to form a camera network. Alternatively, the multi-camera control engine 116 may use connection information stored in the configuration store 314 that identifies remote cameras with which the multi-camera control engine 116 has previously formed a connection.

The multi-camera control engine 116 connects 404 with each of the identified remote cameras to form a camera network. In operation, the multi-camera control engine 116 uses connection information received from the remote cameras (in response to a discovery request) or stored in the configuration store 314 to form the camera network. Each of the remote cameras may also connect with the other cameras in a similar manner such that each camera in the camera network may independently communicate with every other camera in the camera network.

The multi-camera control engine 116 adopts 406 a controller mode among the cameras in the camera network. In the controller mode, when the camera that includes the multi-camera control engine 116 experiences a change of state, the multi-camera control engine 116 broadcasts the change of state over the connections with each of the other cameras in the camera network. The multi-camera control engine 116 determines 408 that the camera in which the engine 116 operates has experienced a change in state. Examples of state changes include but are not limited to: a shutter operation, a lens focus operation, an image capture mode, entering low light mode, entering sleep mode, and a change in a setting of the camera (e.g., image capture resolution, zoom level, etc.). In response to the change in state, the multi-camera control engine 116 broadcasts 410 the new camera state to each of the remote cameras in the camera network. The recipient cameras receive the camera state and locally mimic the state.

The multi-camera control engine 116 also listens 414 for broadcasts of changed states from other cameras in the camera network. When listening for such broadcasts, the multi-camera control engine 116 is configured to operate in a recipient mode. In one embodiment, the multi-camera control engine 116 operates in both the controller mode and the recipient mode simultaneously such that the multi-camera control engine 116 may simultaneously broadcast state changes to and receive state changes from other cameras in the camera network. If a state change is received from another camera in the camera network, the multi-camera control engine 116 mimics, or at least attempts to mimic, the state change locally.

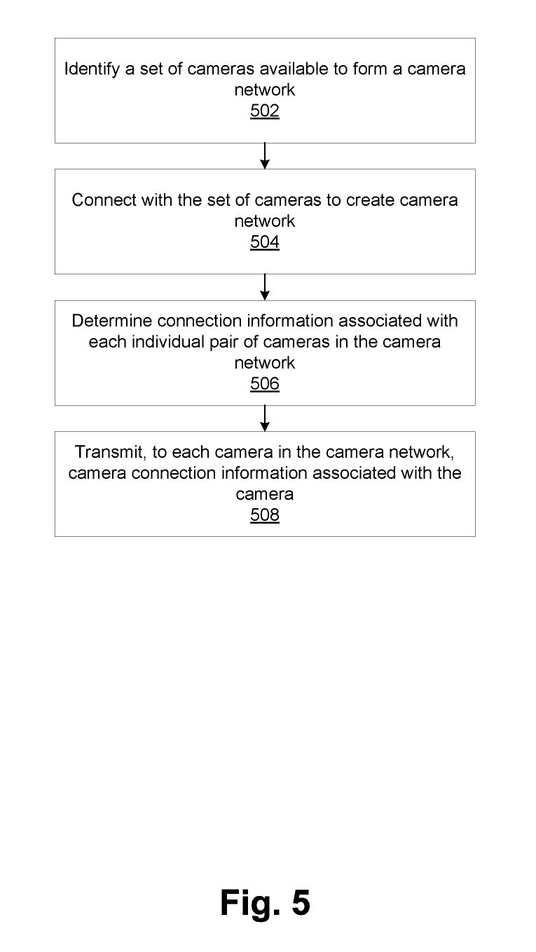

FIG. 5 is a flow diagram illustrating a process for a camera in a camera network to distribute connection information to other cameras in the camera network for forming independent connections with each other, according to one embodiment.

The multi-camera control engine 116 in a given camera identifies 502 a set of remote cameras that are available to form a camera network. The multi-camera control engine 116 connects 504 with each of the identified remote cameras to form a camera network.

The multi-camera control engine 116 determines 506 third party connection information associated with each unique pair of cameras in the camera network. The third party connection information identifies, for each pair of cameras, connection information needed for the pair of remote cameras to connect with one another. The connection information may include a connection address, unique camera identifiers, a unique security key needed for the pair of cameras to connect, and the like. The third party connection information associated with each pair of remote cameras may be provided by a user or may be provided by a remote camera when the local camera connects to the remote camera.

The multi-camera control engine 116 transmits 508 to each camera in the camera network the associated third party connection information needed for that camera to connect with other cameras in the camera network. In one embodiment, a camera receiving the third-party connection information transmits a confirmation notification to the multi-camera control engine 116 indicating that the camera successfully connected to other cameras in the camera network.

### Example Camera System Configuration

A camera system includes a camera, such as camera 100, and a camera housing structured to at least partially enclose the camera. The camera includes a camera body having a camera lens structured on a front surface of the camera body, various indicators on the front of the surface of the camera body (such as LEDs, displays, and the like), various input mechanisms (such as buttons, switches, and touch-screen mechanisms), and electronics (e.g., imaging electronics, power electronics, etc.) internal to the camera body for capturing images via the camera lens and/or performing other functions. The camera housing includes a lens window structured on the front surface of the camera housing and configured to substantially align with the camera lens, and one or more indicator windows structured on the front surface of the camera housing and configured to substantially align with the camera indicators.

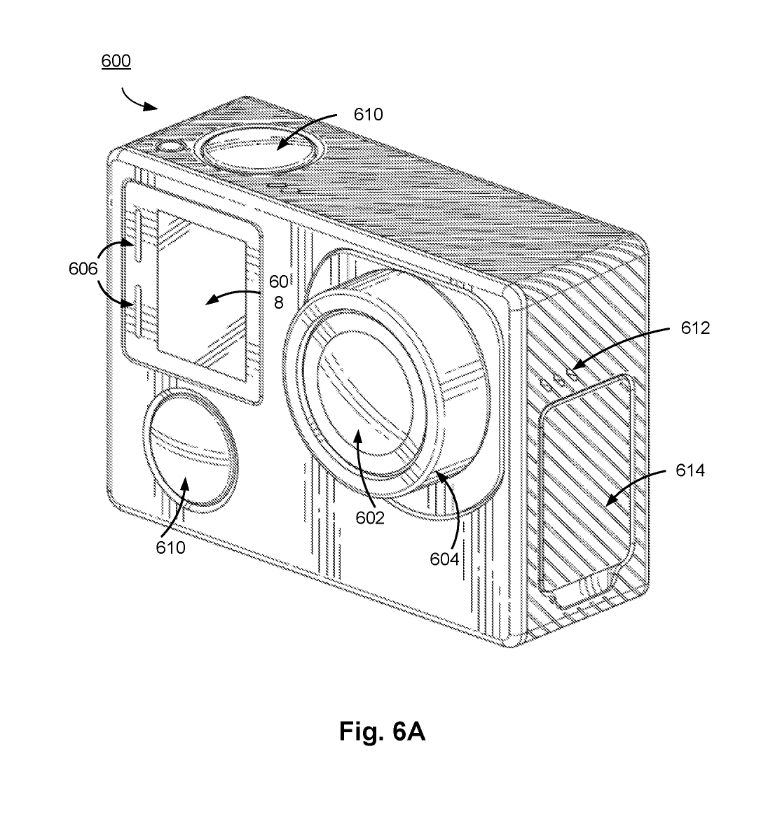

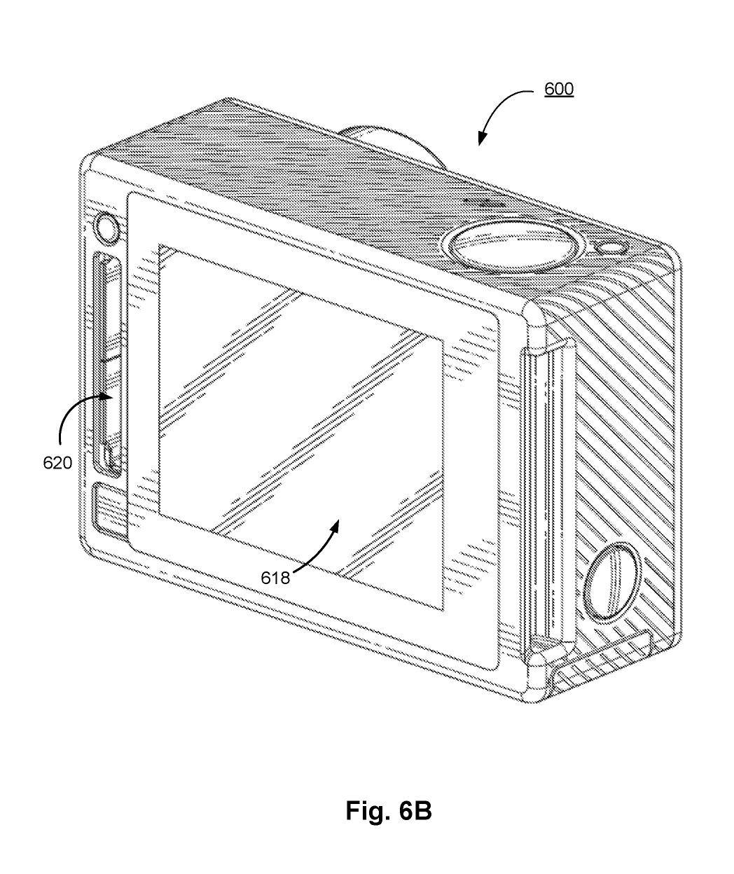

FIG. 6A illustrates a front perspective view of an example camera 600, according to one embodiment. The camera 600 is configured to capture images and video, and to store captured images and video for subsequent display or playback. The camera 600 is adapted to fit within a camera housing. As illustrated, the camera 600 includes a lens 602 configured to receive light incident upon the lens and to direct received light onto an image sensor internal to the lens for capture by the image sensor. The lens 602 is enclosed by a lens ring 604.

The camera 600 can include various indicators, including the LED lights 606 and the LED display 608 shown in FIG. 6A. When the camera 600 is enclosed within a housing, the LED lights and the LED display 608 are configured to be visible through the housing. The camera 600 can also include buttons 610 configured to allow a user of the camera to interact with the camera, to turn the camera on, to initiate the capture of video or images, and to otherwise configure the operating mode of the camera. The camera 600 can also include one or more microphones 612 configured to receive and record audio signals in conjunction with recording video. The side of the camera 600 includes an I/O interface 614. Though the embodiment of FIG. 6A illustrates the I/O interface 614 enclosed by a protective door, the I/O interface can include any type or number of I/O ports or mechanisms, such as USB ports, HDMI ports, memory card slots, and the like.

FIG. 6B illustrates a rear perspective view of the example camera 600, according to one embodiment. The camera 600 includes a display 618 (such as an LCD or LED display) on the rear surface of the camera 600. The display 618 can be configured for use, for example, as an electronic view finder, to preview captured images or videos, or to perform any other suitable function. The camera 600 also includes an expansion pack interface 620 configured to receive a removable expansion pack, such as an extra battery module, a wireless module, and the like. Removable expansion packs, when coupled to the camera 600, provide additional functionality to the camera via the expansion pack interface 620.

What is claimed is:

1. A camera in a camera network including a plurality of cameras, the camera comprising:
a pairing module configured to:
identify connection information for connecting to a first and second camera in the camera network,
forming a first connection with the first camera and a second connection with the second camera in the camera network based on the connection information, the first camera and second camera not connected to each other, and
transmit over the first and second connections third party connection information that enables the first and the second cameras to form a connection to each other;
a broadcast module configured to, when the camera is configured to operate in a controller mode, broadcast over the first and second connections a detected change of state of the camera, wherein each of the first camera and second camera, in response to receiving the broadcasted change of state, are reconfigured to mimic the change of state.

2. The camera of claim 1, wherein the pairing module is further configured to receive the third party connection information from the first camera over the first connection and from the second camera over the second connection.

3. The camera of claim 1, wherein the pairing module is further configured to receive the third party connection information from the user of the camera.

4. The camera of claim 1, wherein the pairing module is configured to receive a notification from the first camera or the second camera indicating that the first and the second cameras have formed the connection with each other.

5. The camera of claim 1, wherein the broadcast module is configured to, when the camera is configured to operate in a recipient mode, receive over the first connection from the first camera a broadcast of a change of state detected by the first camera and reconfigure the camera to mimic the change of state.

6. The camera of claim 5, wherein the camera is configured to operate in the controller mode and the recipient mode simultaneously.

7. The camera of claim 1, wherein, when the camera is configured to operate in the controller mode, the broadcast module is configured to broadcast metadata needed by the first and second cameras to mimic the change of state.

8. The camera of claim 7, wherein the change of state comprises an image capturing state causing the at least the first camera capture an image, and the metadata comprises a tag that is stored with the image captured by the first camera.

9. The camera of claim 1, wherein the third party connection information transmitted to the first camera comprises a connection address associated with the second camera.

10. The camera of claim 1, wherein the third party connection information transmitted to the first camera comprises a unique security key needed for the first camera to connect to the second camera.

11. A method for creating a camera network including a plurality of cameras, the camera comprising:
identifying connection information for connecting to a first and second camera in the camera network;
forming, by a camera, a first connection with the first camera and a second connection with the second camera based on the connection information, the first camera and second camera not connected to each other;
transmitting over the first and second connections third party connection information that enables the first and the second cameras to form a connection to each other; and
when the camera is configured to operate in a controller mode, broadcasting over the first and second connections a detected change of state of the camera, wherein each of the first camera and second camera, in response to receiving the broadcasted change of state, are reconfigured to mimic the change of state.

12. The method of claim 11, further comprising receiving the third party connection information from the first camera over the first connection and from the second camera over the second connection.

13. The method of claim 11, further comprising receiving the third party connection information from the user of the camera.

14. The method of claim 11, further comprising receiving a notification from the first camera or the second camera indicating that the first and the second cameras have formed the connection with each other.

15. The method of claim 11, further comprising, when the camera is configured to operate in a recipient mode, receiving over the first connection from the first camera a broadcast of a change of state detected by the first camera and reconfigure the camera to mimic the change of state.

16. The method of claim 15, wherein the camera is configured to operate in the controller mode and the recipient mode simultaneously.

17. The method of claim 11, further comprising, when the camera is configured to operate in the controller mode, broadcasting metadata needed by the first and second cameras to mimic the change of state.

18. The method of claim 17, wherein the change of state comprises an image capturing state causing the at least the first camera capture an image, and the metadata comprises a tag that is stored with the image captured by the first camera.

19. The method of claim 11, wherein the third party connection information transmitted to the first camera comprises a connection address associated with the second camera.

20. The method of claim 11, wherein the third party connection information transmitted to the first camera comprises a unique security key needed for the first camera to connect to the second camera.
